(19) United States
(12) Patent Application Publication
(10) Pub. No.: US 2008/0005271 A1
(43) Pub. Date: Jan. 3, 2008

(54) DATA LOGGING FOR RESIDENT APPLICATIONS WITHIN PORTABLE ELECTRONIC DEVICES

(75) Inventors: Shumeet Baluja, Alexandria, VA (US); Eric Wilson, Brentwood, CA (US); Suddhasattwa Bose, Venice, CA (US); Hyosung Han, Redondo Beach, CA (US)

Correspondence Address: TOWNSEND AND TOWNSEND AND CREW LLP/EA, TWO EMBARCADERO CENTER, 8TH FLOOR, SAN FRANCISCO, CA, 94111, US

(73) Assignee: Electronic Arts Inc.

(21) Appl. No.: 11/679,476

(22) Filed: Feb. 27, 2007

Related U.S. Application Data
(63) Continuation of application No. 11/225,240, filed on Sep. 13, 2005, now abandoned.
Application No. 11/225,240 is a continuation of application No. 10/142,121, filed on May 9, 2002, now abandoned.
(60) Provisional application No. 60/354,791, filed on Feb. 6, 2002.

(51) Int. Cl. G06F 15/16

(52) U.S. Cl. 709/217

(57) ABSTRACT

A method for gathering data from a portable communication device. The method comprises providing at least one application that runs in the communication device. The application includes code or calls to code as part of the application that provides data to a data log. At least a portion of the data log is transmitted to an external source. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or the meaning of the claims.

### CROSS-REFERENCE TO RELATED APPLICATIONS

The present application is a continuation of application Ser. No. 11/225,240, filed on Sep. 13, 2005, which is a continuation of copending patent application, Ser. No. 10/142,121, filed May 9, 2002, which claims priority to provisional application, Ser. No. 60/354,791, filed Feb. 6, 2002, the contents of all three of which are expressly incorporated herein by referenced as though fully set forth in full.

### BACKGROUND

1. Field

The present invention relates to wireless communications systems.

2. Background

The amount of wireless data from all sources continues to increase. As wireless communications increases, more applications which include wireless data are being developed and used. Additionally as memory density increases, more memory can be included in portable communications devices. As the amount of memory available on portable devices increases, the number of applications that can be accommodated in wireless devices increases. As the number of applications available for portable devices continues to increase, more is invested in the creation of such applications. Additionally, because more storage area is becoming available, the size of such applications also tends to increase as does the number of features available for each application. As investments in such applications increase, the performance of such applications becomes more and more critical.

In order to determine criteria for user acceptance of such applications, various methods may be employed. For example, users may be directly queried about their likes and dislikes of the various applications. However, there is a resistance by consumers to responding to consumer surveys. A more effective way of examining a user's use and acceptance of an application is to examine the use itself. Given user reluctance to take surveys, fill out questionnaires or in other ways respond to queries on their use of a particular application, it may be difficult to obtain accurate representations of users' impressions and uses of such applications. Accordingly, there is a need in the art for methods to evaluate users' use of applications in portable wireless communications systems which are transparent to the user and do not affect their use of the application.

### SUMMARY

In one aspect of the present invention, a method of logging data includes executing an application within a communications device, logging data related to the execution of the application to a data log, and transmitting data from the data log to an external source.

In another aspect of the present invention, a communications device includes a data log, a processing element configured to execute an application within the communications device, and log data relating to the execution of the application to a data log, and a transmitter configured to transmit the data to an external source.

In yet another aspect of the present invention, computer readable media embodying a program of instructions executable by a computer performs a method including executing an application within a communications device, logging data relating to the execution of the application to a data log, and extracting data from the data log for transmission to an external source.

In a further aspect of the present invention, a communication device includes means for executing an application within the communications device, means for logging data relating to the execution of the application to a data log, and means for transmitting data from the data log to an external source.

It is understood that additional aspects of the present invention and variations thereof will become readily apparent to those skilled in the art from the following detailed description. The following descriptions illustrate and describe exemplary embodiments of the invention, simply by way of illustration. As will be realized, the invention is capable of other and different embodiments, and its several details are capable of modifications in various respects, all without departing from the scope of the disclosed invention. Accordingly, the drawings and description are to be regarded as illustrative in nature, and not as confining the inventive concepts to the illustrations disclosed.

### BRIEF DESCRIPTION OF THE DRAWINGS

Aspects of the present invention are illustrated by way of example, and not by way of limitation, in the accompanying drawings in which like reference numerals refer to similar elements wherein:

FIG. 1 is a graphical illustration of an environment in which embodiments of the invention may be used.

FIG. 2A is a graphical illustration of the handling of requests for data and replies, from a portable communications system.

FIG. 2B is a graphical illustration of the handling of requests for data and replies, from a portable communications system in which the service carrier does not do the logging.

FIG. 3A is a graphical illustration of application event logging in a portable communications device, exemplarily a cell phone.

FIG. 3B is a graphical illustration of a further application event logging in a portable communications device, exemplarily a cell phone.

FIG. 3C is a graphical illustration of another application event logging in a portable communications device, exemplarily a cell phone.

FIG. 4A is an exemplary graphical illustration of application event logging in a portable communications device.

FIG. 4B is another exemplary graphical illustration of application event logging in a portable communications device.

FIG. 4C is yet another exemplary graphical illustration of application event logging in a portable communications device.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and devices are shown in block diagram form in order to avoid obscuring the concepts of the present invention.

In an exemplary embodiment of a wireless communications system, tracking or data logging techniques can be employed to monitor the usage of various applications. This can be achieved by including tracking or data logging code in the application. Such tracking or data logging code may be harmonized so that multiple applications can cooperatively operate in an efficient manner, without interfering with one another. Such data logging may be accomplished transparently to the user, as may the transmission of the data.

Various aspects of data logging and reporting will be described in the context of a cell phone communications system, however, those skilled in the art will appreciate that methods of data logging and transmission are likewise suitable for use in various other portable communications environments. Accordingly, any reference to cellular communications is intended only to illustrate the inventive aspects of the present invention, with the understanding that such inventive aspects have a wide range of applications in other portable electronic devices, such as programmable digital assistants. (PDAS) and the like, and that the inventive concepts herein in no way depend on the use of cellular telephones. The inventive concepts herein also do not depend upon the existence of a wireless connection, as aspects of the present invention can be implemented in systems in which the connection is a physical connection, such as a wired connection.

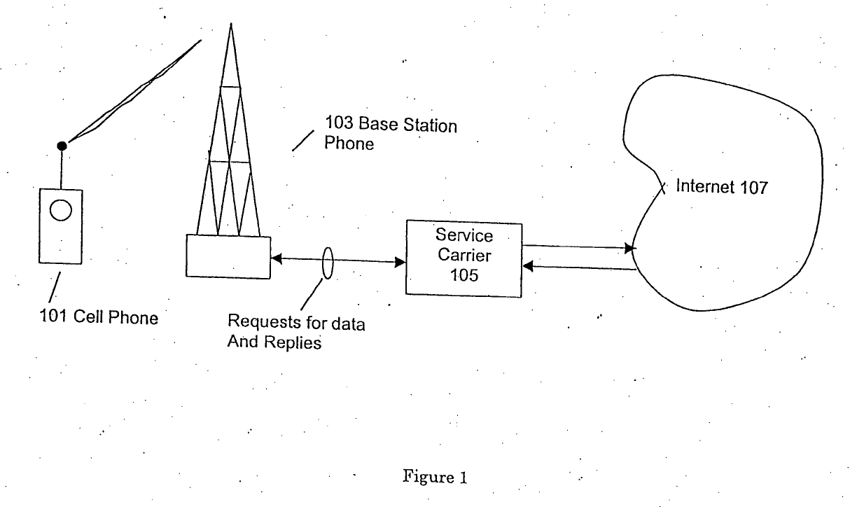

FIG. 1 is a graphical illustration of an exemplary communications system. In FIG. 1 an exemplary cellular telephone 101 communicates with a base station 103. The data communications between the cellular telephone 101 and the base station 103 include requests for data, which are transmitted from the cellular telephone 101, and replies, which provide data to the cellular telephone from the base station 103. Commonly, the cellular telephone 101 communicates with the base station 103, which is in its cellular area. As the cellular telephone 101 moves to another cellular area it will commonly communicate with another base station (not shown). The requests for data are relayed by the base station 103 to a service carrier 105. The data link between the base station 103 and the service carrier 105 may be any type of link known in the art, for example a telephone line conductor, a microwave link or fiberoptic link. The service carrier 105 provides replies to requests for data from the base station 103. The base station 103 in turn communicates the requested data to the cellular telephone 101. The service carrier 105 communicates with a source of data, such as the Internet 107. The use of the Internet as a source of data is used for the purpose of illustration only and other repositories of data could be equivalently substituted. Additionally, the service carrier 105 is not limited to only one data connection, such as the Internet 107 shown. It may communicate with additional sources of data, for example optical storage, raid (redundant array of inexpensive disks) storage or other data sources well known in the art.

Requests for data and replies may be of various forms. For example, the cellular telephone 101 may request a download of data in order to play a game on the cellular telephone 101. The data request may also be gaming parameters interchanged between the cellular telephone 101 and remote users who are playing against, or in cooperation with the cellular telephone 101 user. In such a way, interactive games can be played by a variety of users in a large geographical area. Another example of an application that may be present within the cellular telephone 101 is that of a stock quote application. The cellular telephone user can communicate with a website, which may send the cellular telephone stock quotes, price alerts, trends, etc. The different types of applications, which may be contained in portable wireless communications systems, such as the exemplary cellular telephone 101, are effectively limitless. With the appearance of cellular telephones containing web browsers virtually any type of Internet application can be accessed. Generally, it is desirable to analyze the trends in this type of communications application to improve portable communications applications.

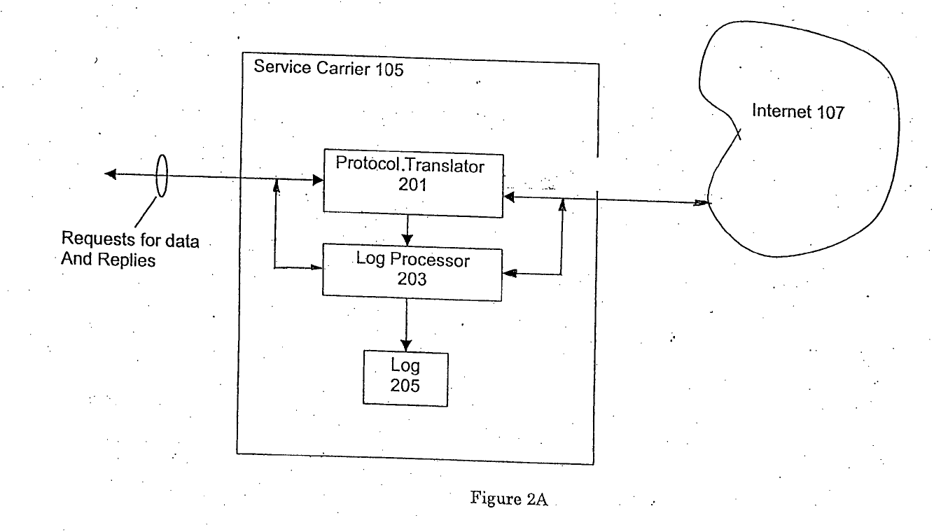

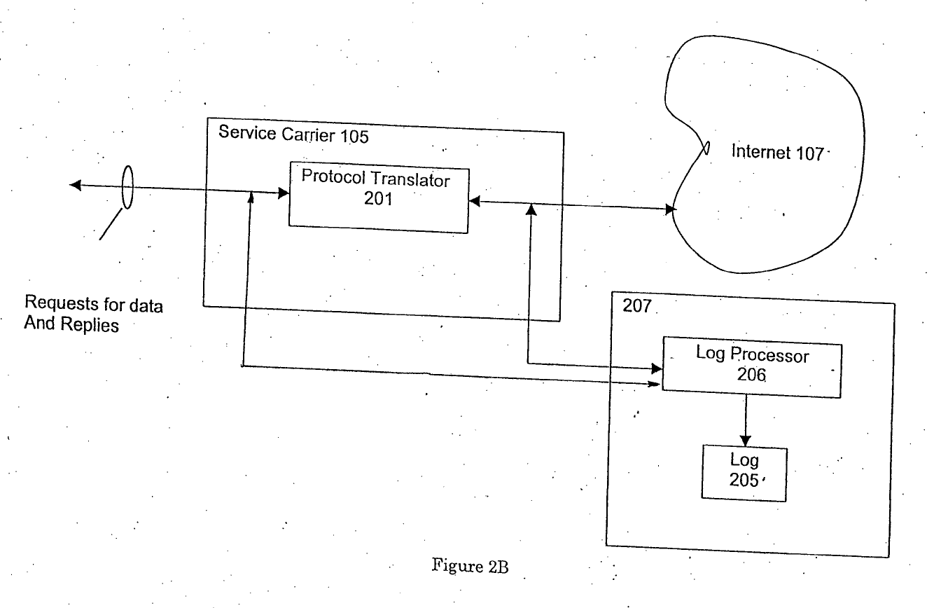

FIG. 2A is a graphical representation illustrating an exemplary technique to produce a data log 205 of traffic between the base station 103 and the cellular telephone 101. In FIG. 2A the service carrier 105 accepts the requests for data and provides replies. The requests for data are translated in a protocol translator 201, which translates the requests for data into a protocol which can be recognized by the data provider such as the Internet 107. The protocol translator 201 also accepts communications from the data provider such as the Internet 107 and translates it into an appropriate form to be further transmitted to the base station 103 and further transmitted to the cellular telephone 101. A log processor 203 may log the requests for data to and from the cellular telephone in a log 205. The protocol translator is optional—data can be forwarded directly without any change in the protocol. In either case, the logging is done by monitoring the communication that occurs at the service provider between the cellular telephone 101 (or any device to be monitored) and the Internet (or any data source).

If an application is downloaded to the cellular telephone 101 it is useful to know how effective that application is. Application designers may wish to know the answers to questions such as: Is the application performing as the user expects it? If the application provides its own requests for data, are the requests timely? What kind of response time does the application provide? How extensive is the use of the application? What parts of the application are most frequently used? Which parts of the application are hardly ever used? How often is the application used? What is the duration of use of the application? What is the time of use per hour, day, week, month etc? A data log resident within the cellular telephone 101 may provide much of this type of information. Such an improved log can provide not only simple counting functions, such as numbers representing the peak number of requests, average length of requests and so forth, but may provide additional information with regard to the use of data within the cellular telephone 101.

This concept can be extended to generate log entries based on billable events. For example, an application designer may wish to charge specialized fees for significant events that occur during game use. Examples of specialized fees as they relate to significant events in a game could be: use of particular game features, “weapons” or attributes about the game. The application designer may also choose to award players monetary or other incentives for achieving a high score or playing the game for a certain amount of time. Or the application designer may wish to charge for the game based upon the amount and type of usage. A golf game designer may wish to bill based on the courses that are played. All aspects of usage can be recorded in the data log and transferred back to a collection system with the rest of the recorded event data. From the usage logs, billing events can be extracted and used to generate billing statements. In general, all events related to usage, whether for improving the application, monitoring the application or billing for use of the application can be logged into single or multiple client-side data logs. When the data logs are gathered and processed, whether on the device or at a service provider or at a third party, these events can be forwarded to their respective destinations.

FIG. 2B is a graphical illustration of the handling of requests for data and replies from a portable communications system in which the service carrier does not do the logging. In FIG. 2B the requests for data may be written to the data log 205 by a log processor 206. The data log 205 and log processor 206 may be located at a site 207 separate from the service carrier 105. The site 207 may be any convenient location.

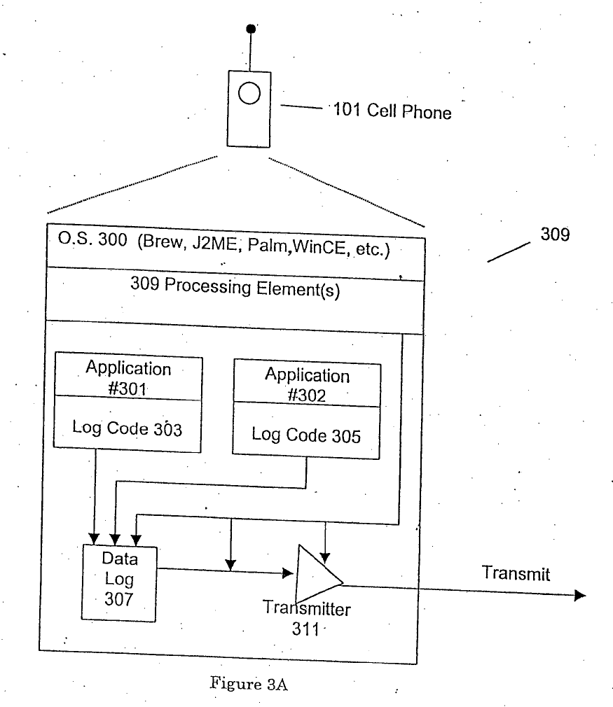

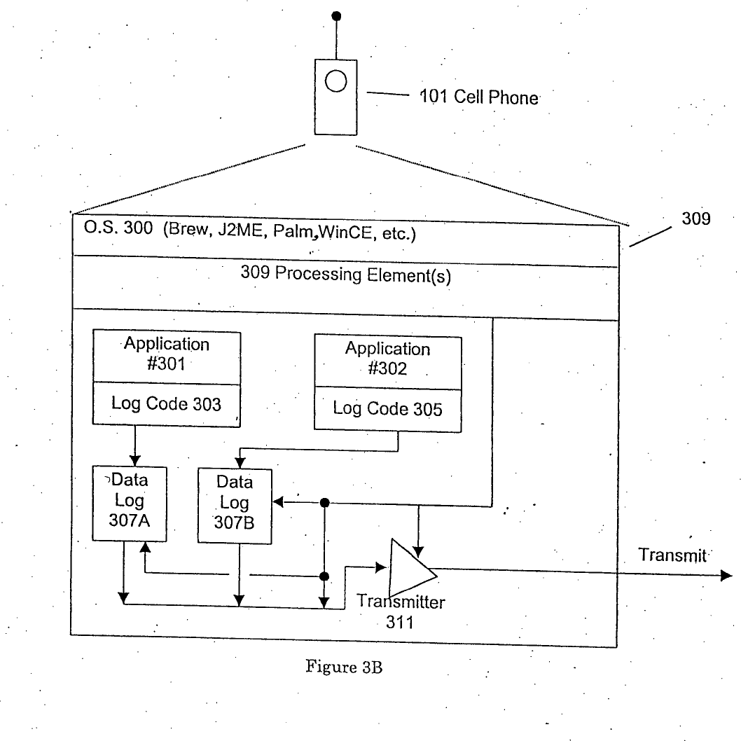

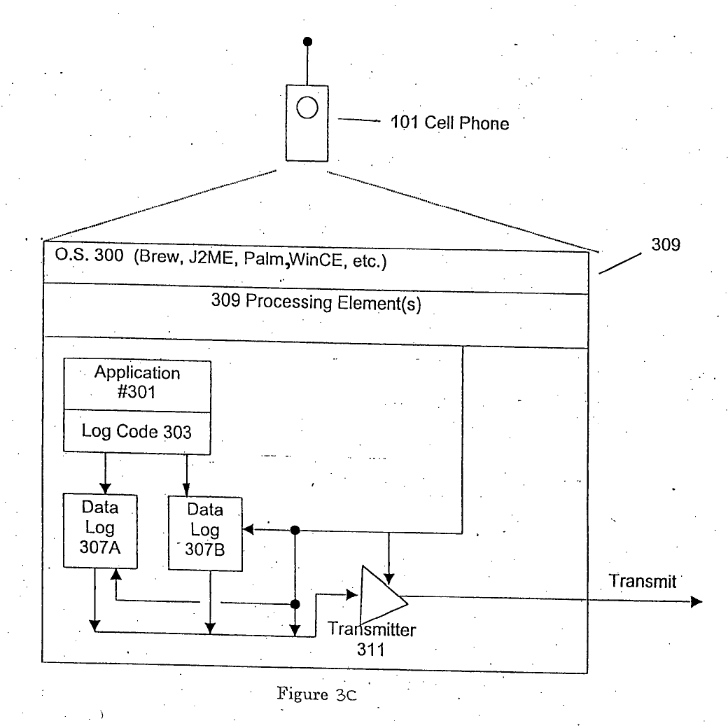

FIG. 3A is a graphical illustration of application event logging in a portable communications device, such as the exemplary cellular telephone 101. In FIG. 3A, the inner workings of the cellular telephone 101 are graphically illustrated at 309. The cellular telephone 101 may have an operating system 300 or application execution environment in order to manage the electronic functions of the cellular telephone 101. A variety of operating systems may be used such as the palm operating system, the Windows CE operating system, the BREW operating system (binary run time environment for wireless), the J2ME (JAVA-2 Platform Micro Edition) operating system, and the like. The operating system 300 or application execution environment may provide resources and coordination for the applications, which are executing within the cellular telephone, such as application 301 and application 302. There may be multiple applications within the cellular telephone 101 and multiple applications may be executing or lying dormant waiting for an event.

The applications are commonly executed by one or more processing elements 309 such as microcontrollors, sequencer circuits, state machines or the like. Each application within the cellular telephone 101 contains log code. Application 301 contains a log code 303. Application 302 contains a log code 305. Each of the applications uses the log code to write event data to a data log 307. The term “data log” refers to a portion of memory dedicated to recording events for one or more applications. Writing to the data log 307 may be controlled by functions of the operating system 300 or the application execution environment, directly, or indirectly by log code within each application. Before being written to the data log 307, the data may be compressed by any algorithm known in the art to conserve memory resources. The log code within each application is designed so as not to interfere with the log code from another application. That is, the log code is so constructed such that data logged by one application will not be corrupted by data logged by another application.

The data from the data log 307 can be transmitted to the base station 103 and then provided to application developers, the service carrier 105 or whomever has an interest in such data. The data log 307 may contain data written by multiple applications.

In the illustration of FIG. 3A, the data log 307 may contain data requests, but may also contain any information desired regarding the functioning of the applications, and about the user's interaction with the application. For example, if the user had requested the download of a golf game, the types of golf clubs used, the number of holes played in the golf game, the time of day the game is played, and the duration of play might be logged for use in providing feedback to the golf game designer. In another example, the data may be which stocks are most commonly traded or which sports scores are most commonly requested. Further data may be collected on what times of day applications are used.

Once the data log 307 has been written, it may be transmitted to the base station 103, using a transmitter 311, and later provided to those interested in such data. Various modes of transmission are possible. A first mode of transmission is when a portable communications device, such as the cellular telephone 101, initiates its own communications, to transmit the data from the data log 307. Such a scheme could be triggered by the data log filling to a certain point thereby causing the cellular telephone 101 to initiate the call to download the data from the data log 307. Such a method is simple and straightforward, however, there is no guarantee that the data can be transmitted once the data log 307 is filled to a certain level. Accordingly, to keep the data log 307 from overflowing, the level of the data log 307 which initiates a transmission may have to be unacceptably low, and therefore, the data log 307 may need to transmit more frequently. Additionally, the user of the cellular telephone 101 wishing to use it for other purposes such as, for example, placing a telephone call may interrupt such transmissions.

Another mode of transmitting data from the data log 307 is to transmit data in response to a trigger such as the occurrence of an event. For example, the data can be transmitted from the data log 307 every time the application is started or when a particular event occurs during the execution of the application. Alternatively, the data could be transmitted from the data log in response to a request from the base station 103.

Alternatively, the data from the data log 307 can be transmitted opportunistically. That is to include data, from the data log 307, in a transmission originated for another purpose. For example, in every communications between the cellular telephone and the base station 103, a portion of the bandwidth, though allotted to that communications, remains unused. The unused bandwidth could be used to transmit the data. For example, in a digital type cellular telephone, the voice conversations are commonly converted into digital data, packetized and transmitted in packet form. Such a transmission may be initiated by the processing element 309 activating the transmitter 311. If bandwidth is allocated to communicate to and from the cellular telephone 101, then that bandwidth is allotted to the cellular telephone 101 whether any telephone conversation is being transmitted back and forth or not. In other words, whether any data is transmitted back and forth the same amount of bandwidth may be reserved for use by the cellular telephone 101. The data from the data log 307 may be transmitted using the transmitter 311 every time that space becomes available in the bandwidth, that is when the cellular telephone 101 is not being used to communicate. Since the allocation of transmission bandwidth is known to the processing element 309, it can intersperse the data log 307 data, with the data being transmitted to convey the telephone conversation, and both may be transmitted by transmitter 311, without interfering with the telephone conversation. There are commonly, multiple transmission opportunities when the cellular telephone 101 is used to place a call as data packets can be transmitted between spoken words and while data is being received. Such an opportunistic transmission also has an advantage in that it does not consume additional bandwidth to transmit the data, rather it uses the bandwidth which otherwise would remain unused and wasted. Additionally, because the use of the cellular telephone is likely to be quite frequent, the data log 307 can continually be emptied opportunistically thereby reducing the chance of having an overflow condition in which the memory allotted to the data log 307 is inadequate.

Piggybacking data on other data or voice communications transmissions may also be used to opportunistically transmit data in other applications as well. By transmitting whatever data is available whenever a transmission takes place, the reporting from the data log 307 may be made transparent to the user. Additionally, by piggybacking data on other transmissions, no call needs to be initiated. The amount of data piggybacked can be limited so that it only forms a small portion of the transmission.

A further advantage of the data log 307 is that it may log events from the application, which are not related to requests for data. For example, if the application is a stock pricing programmed by the cellular telephone user, the behavior of the user and inputs to that application may be logged. For example, the average number of keystrokes per activations (and what those keystrokes were) could be logged in order to determine more efficient user interfaces. Such logging may be transparent to the user of the application. That is the user of the application need not know that the log is being generated and the log will not interfere with the user's use of the application. Alternatively, the user may consent to taking part in such a user application study. Additionally, by utilizing opportunistic transmission from the data log 307 there will not be an additional cost or air time being attributed to the user. Opportunistic transmission can occur whenever a transmission is initiated to transmit for a purpose not related to the data log 307. Once the transmission is initiated, data from the data log 307 may be piggybacked on the already initiated transmission. By having the log code resident as part of each application (e.g. 303), logging can be done completely transparently as can the data transmission.

The log code 303 may be included along with each application that is downloaded to the cellular telephone 101. Additionally, any application, which is resident in the cellular telephone 101, may come equipped with such logging code. Such logging code can provide application developers with valuable information on how their application is used, and therefore, how they may improve it. Additionally, by having cooperating log code with each application, an uncorrupted log 307 may be generated. As an alternative to embedding the logging code in each application, the logging code may be incorporated as a part of the operating system 300 or application execution environment. The data log 307 in turn may be created and managed by the operating system 300, or the application execution environment, or by the cooperative use of logging code among applications. If the data log 307 were created by an operating system, or application execution environment, function then the data log 307 could be used by any resident or downloaded application. If the data log was 307 not a part of an operating system, or application execution environment, function then it might be created by the first application to require its use. Put in other words, the first application to have the logging code could detect that no data log had been created and create data log 307. Subsequent applications would not need to create the data log 307, they could detect that the data log 307 had already been created. Applications may write to the data log 307 and not corrupt each other's data logging by using software techniques, such as the locking of the data log 307, well known in the art. In some embodiments, the application can detect when the data log is locked and create a second data log for recording events during that period. This concept can also be extended to situations where the application is transmitting data from the first data log opportunistically, or otherwise, but needs to continue to monitor certain events. In this case, a second data log can be created for that purpose.

Additionally, the requests for data made by the applications could be stored in the data log 307, thereby eliminating the need for the data log 205 at the service carrier 105 such as illustrated in FIG. 2A. Because each cellular telephone could maintain its own data log, the need for some of the processing of the data log searching through the data log 205 at the service carrier 105 for data related to one user may be mitigated. When such data is transmitted it may be appended to previously transmitted data from the same cellular telephone if desired. In such a way, a particular user's data log could be generated as the logging is done. Techniques for linking data using a variety of criteria, such as by user, type of application and so forth are well established in the art.

In order to discern patterns within the data log 205 in FIG. 2A, the data log 205 may be searched. In contrast, data transmitted from cellular telephones may already contain aggregate data thereby eliminating the more time consuming process of searching and sorting through the log at the service carrier. When data is transmitted from the data log 307, it could be already aggregated by cellular telephone user, by application, by time of day, or any other conceivable criteria desired before being transmitted. By building up a database prior to transmission of the data, user trends may be identified and use of computer resources to search and sort through a log database such as the log illustrated at 205 at the service carrier 105 could be, at least partially, avoided. Additionally, the data from the data log 307 could be communicated to the end user application as it was transmitted.

In addition, if the log code were contained within each application, the data log could be deleted when no longer required. The trigger to delete the data log could be initiated by the application that requested an event to be logged, the operating system or the application environment, or could be automatically triggered based on the successful completion of the send-log-event.

If the logging code and data log were functions provided by the operating systems 300, or application execution environment, each application would only need contained calls to the proper API (application programming interface) in order to log the data event. To the extent the APIs reside in the operating system or application execution environment, the application code can be reduced.

An additional advantage of including logging code within an application is that when the application is improved the logging code included with the application may also be changed. For example, if a user downloads a game, the use of the game may be monitored through the use of logging code and the data log as previously described. Once the data from multiple users has been used to improve the game, a new version with new logging code may be downloaded and used to monitor the use of the new version of the game. The same principle applies to any application which may be used within the cellular telephone or portable communications device. In such a way applications may be monitored and continually improved. Alternatively, the logging code itself may be an application. Other applications may call the logging code application during their execution. In the case where the logging code were implemented as an application, the logging code could be updated without having to affect the operating system, or application execution environment, code 300.

FIG. 3B is a graphical illustration of a further application event logging in a portable communications device, exemplarily a cell phone. FIG. 3B is similar to FIG. 3A except that the application 301 and the application 302 write to separate data logs. Each data log 307A and 307B is defined as a portion of memory dedicated to record events associated with its respective application 301 and 302. Both data logs 307A and 307B may exist on a single memory device, or alternatively, exist on separate memory devices. This configuration may provide several advantages, for example, the logs 307A and 307B may be prioritized so that more important data receives a transmission priority. The separate data logs may be dedicated to certain events. For example, one could be used for billing events and one could be used for data mining events. Additionally, because there are separate data logs, the separate applications do not have to contend for access to a single log, thereby possibly simplifying the software. The data from the log 307A and the log 307B may be sequenced for transmission in transmitter 311 in any way desired.

FIG. 3C is a graphical illustration of another application event logging in a portable communications device. In this embodiment, the application 301 can be configured to write to multiple data logs 307A and 307B. This capability may provide various advantages. For example, the first data log 307A can be created to record events during the execution of the application 303. At some point, the first data log 307A can be locked by means well known in the art and the data transmitted to the base station. During the transmission of the data from the first data log 307A, the second data log 307B can be created to record subsequent events as the execution of the application 303 continues. Once the transmission of the data from the first data log 307A is complete, the first data log 307A can be deleted, or alternatively, the second data log 307B can be locked in preparation for data transmission and the first data log 307A can be used to record new events that occur as the execution of the application 303 continues.

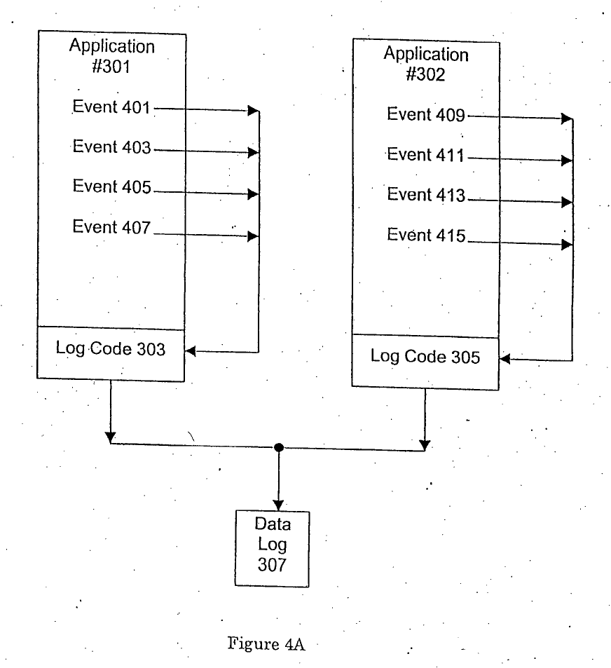

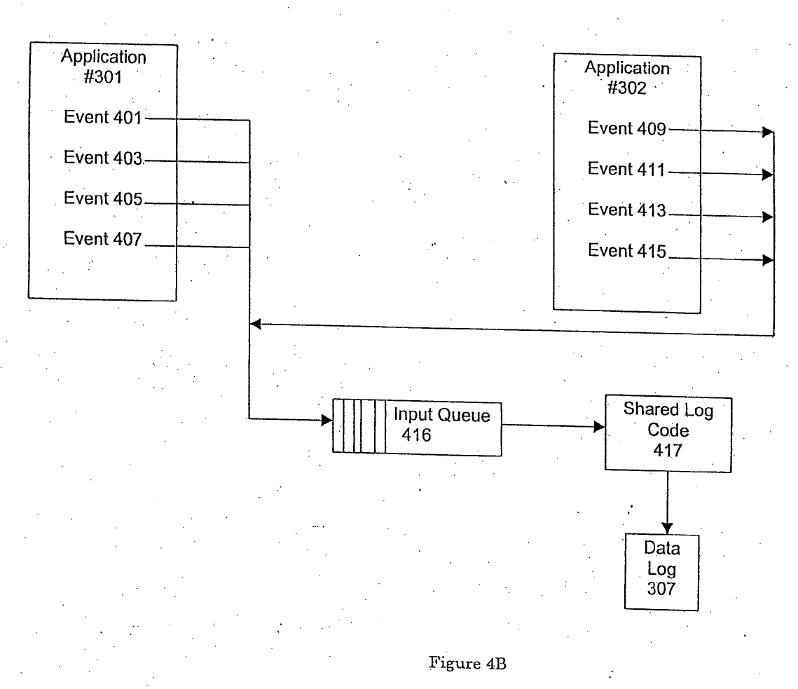

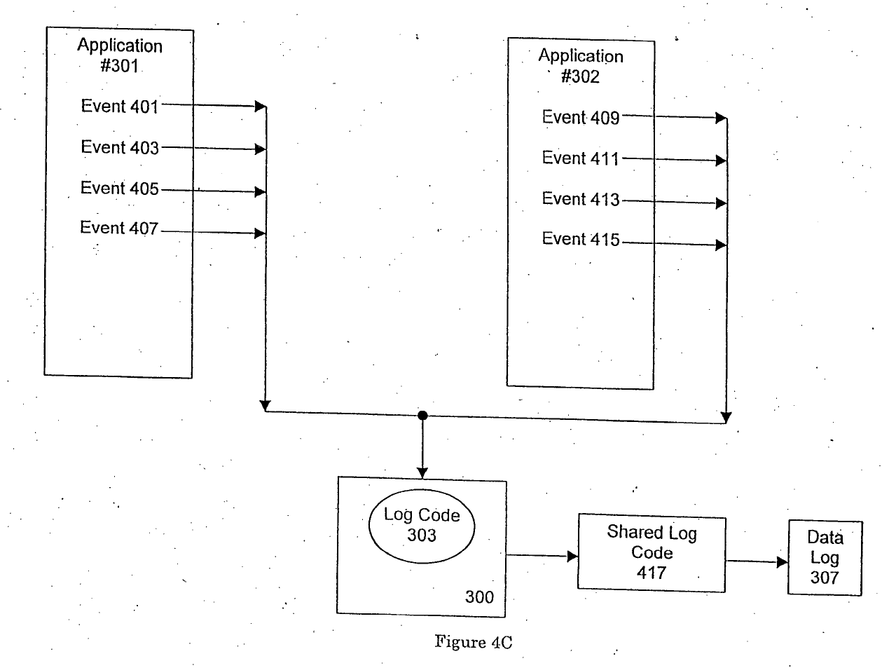

FIG. 4A is a graphical illustration of an application event logging technique in a portable communications device. In FIG. 4A the application 301 includes four events 401, 403, 405 and 407 which are software events, the occurrence of which is desired to be logged. Similarly, the application 302 has four events 409, 411, 413 and 415 desired to be logged. The occurrence of event 401 becomes a logical trigger for the log code 303 to write to the data log 307. Similarly, each of events 401, 403, 405 and 407 become a logical trigger for the log code to write the occurrence of the event to the data log 307. Log code 303 can be tailored as desired. For example, if event 401 is the start of the use of application 301 and event 407 is the termination of application 301, log code may contain the times that the event 401 and event 407 occurred, for example by retrieving the time from the operating system 300, or application execution environment. Similarly, if event 403 is a request for a stock quote, then log code 303 may only record the number of times that the event has occurred. In such a way, any type of event can be tracked. The parameters of an event can be defined and the logging code to accommodate the recordation of that particular event defined. The writing to the data log 307 may be controlled by cooperative multi-tasking between applications using various techniques that are well known in the art. Additionally, applications may request access to the data log 307 through an operating system, or application execution environment, such as one described in connection with FIG. 3A. In such a way, the data log 307 can be prevented from being corrupted by the log codes such as 303 and 305 writing simultaneously to the same area in the data log 307. Alternatively, each application may have its own data log. In such a case, the data log may be a dynamic memory element in which memory is allocated as needed. In such a case, the log code of each application may still cooperate in drawing memory as needed from a common pool.

FIG. 4B is a graphical illustration of an alternative application event logging technique in a portable communications device. In FIG. 4B, the events from each of the applications, i.e., the application 301 and the application 302, do not have their own data logging code. Instead the application 301 and the application 302 utilize a shared log code 417. Depending on the rapidity of the events 401 through 415, the shared log code may need an input queue in order to temporarily store events prior to the shared log code 417 writing the events into the data log 307. The input queue 416 may exist in order to manipulate the events so that they may be compressed in order to take up the least amount of space in the data log 307. The queue may be a dynamic type queue so that it does not permanently impact the amount of storage available overall. In embodiments without an input queue, the applications 301 and 302 can directly access the shared log code 417.

FIG. 4C is a graphical illustration of application event logging in a portable communications device. In FIG. 4C the individual events, i.e. 401, 403, 405 and 407 in the application 301, and the events 409, 411, 413 and 415 in the application 302 call the log code 303 which is part of the operating system 300 or application execution environment. The log code 303 can then activate shared log code 417 in order to write into the data log 307. Of course, instead of being embedded in the operating system 300 or application execution environment, the log code 303 may be part of a stand alone logging application, which may also contain the shared log code 417.

Those skilled in the art will appreciate that the various illustrative logic blocks, components, modules, circuits, and algorithms described in connection with the embodiments disclosed herein may be implemented as electronic hardware, computer software, or combinations of both. To emphasize the interchangeability of hardware and software in the described exemplary embodiments, the various illustrative logic blocks, components, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, components, modules, and circuits described in connection with the exemplary embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, state machine or any form of digital logic. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the exemplary embodiments is provided to enable any person skilled in the art to make or use the present invention. Various modifications to these embodiments will be readily apparent to those skilled in the art, and the generic principles defined herein may be applied to construct other embodiments without departing from the spirit or scope of the invention. Thus, the present invention is not intended to be limited to the embodiments shown herein but is to be accorded the widest scope consistent with the principles and novel features disclosed herein.

1. A portable communications device, comprising:
a data log;
a processing element configured to execute an application within the portable communications device, the application being configured to make an application programming interface (API) call to control the execution of a logging code that logs events occurring during the execution of the application to the data log; and
a transmitter configured to transmit the logged events from the data log to a remote site.

2-8. (canceled)

9. The portable communications device of claim 1 further comprising a second data log, and wherein the processing element is further configured to execute a second application configured to make the API call having to control the execution of the logging code that logs events occurring during the execution of the second application to the second data log.

10. The portable communications device a claim 1 wherein the processing element is further configured to execute a second application configured to make the API call to control the execution of the logging code that logs events occurring during the execution of the second application to the data log.

11. The portable communications device of claim 1 further comprising a second data log, and wherein the processing element is further configured to log the events occurring during the execution of the application to the second data log when the transmitter is transmitting the logged events from the data log.

12-14. (canceled)

15. The portable communications device of claim 1 wherein the logging code causes the data log to be created when the application is launched by the processing element.

16. The portable communications device of claim 1 wherein the portable communications device comprises a wireless telephone.

17. The portable communications device of claim 1 wherein the portable communications device comprises a personal digital assistant.

18. The portable communications device of claim 1 wherein the processing element is further configured to download the application from the external source before the execution of the application.

19-23. (canceled)

24. The portable communications device of claim 1 wherein the logging code causes the processing element to determine whether the data log exists when the application is launched by the processing element, and creating the data log if the processing element determines that the data log has not yet been created.

25. The portable communications device of claim 1 wherein the application comprises code that allows a user to play a game on the portable communications device when the application is executed by the processing element.

26. A portable communications device, comprising:
an operating system having application programming interfaces that provide logging code and a data log;
a processing element configured to execute an application within the portable communications device, the application including code that interfaces with the application programming interfaces to control the logging code in the operating system to log events occurring during the execution of the application to the data log; and
a transmitter configured to transmit the logged events from the data log to a remote site.

27. The portable communications device of claim 26 wherein the application programming interfaces provide a second data log, and wherein the processing element is further configured to execute a second application, the second application having code that interfaces with the logging code in the operating system to log events occurring during the execution of the second application to the second data log.

28. The portable communications device a claim 26 wherein the processing element is further configured to execute a second application having code that interfaces with the logging code in the operating system to log events occurring during the execution of the second application to the data log.

29. The portable communications device of claim 26 wherein the application programming interfaces provide a second data log, and wherein the code in the application interfaces with the logging code in the operating system to log events occurring during the execution of the application to the second data log when the transmitter is transmitting the logged events from the data log.

30. The portable communications device of claim 26 wherein the logging code in the operating system causes the data log to be created when the application is launched by the processing element.

31. The portable communications device of claim 26 wherein the portable communications device comprises a wireless telephone.

32. The portable communications device of claim 26 wherein the portable communications device comprises a personal digital assistant.

33. The portable communications device of claim 26 wherein the processing element is further configured to download the application from the external source before the execution of the application.

34. The portable communications device of claim 26 wherein the logging code in the operating system causes the processing element to determine whether the data log exists when the application is launched by the processing element, and creating the data log if the processing element determines that the data log has not yet been created.

35. The portable communications device of claim 1 wherein the application comprises code that allows a user to play a game on the portable communications device when the application is executed by the processing element.
